(19) United States
(12) Patent Application Publication
(10) Pub. No.: US 2024/0257271 A1
(43) Pub. Date: Aug. 1, 2024

(54) SYSTEM AND METHOD FOR REPORTING INAPPROPRIATE CONDUCT IN ONLINE DATING

(71) Applicant: Stephen J. Driscoll, Wallingford, PA (US)

(72) Inventor: Stephen J. Driscoll, Wallingford, PA (US)

(21) Appl. No.: 18/403,655

(22) Filed: Jan. 3, 2024

Related U.S. Application Data
(60) Provisional application No. 63/436,792, filed on Jan. 3, 2023.

(51) Int. Cl. G06Q 50/00

(52) U.S. Cl. CPC G06Q 50/01

(57) ABSTRACT

A method of monitoring inappropriate behavior comprising: (a) receiving a report from a first user of an ODA accusing a second user of said ODA of inappropriate behavior, said report including one or more identify parameters of said second user, and a selection from a list of inappropriate behaviors, wherein said report is anonymized to prevent public disclosure of said first user's identity; (b) matching said one or more identify parameters of said report to one or more stored identify parameters of other reports in a datastore; (c) determining if said second user has a pattern of inappropriate behavior if said one or more identify parameters of said report match said one or more stored identify parameters; and (d) if said pattern of inappropriate behavior is determined, providing an indication of said second user's inappropriate behavior to users of a plurality of ODAs

### RELATED APPLICATIONS

The present application is based on U.S. Provisional Application No. 63/436,792, filed Jan. 3, 2023, which is hereby incorporated by reference in its entirety.

### FIELD OF INVENTION

The subject matter relates, generally, to reporting inappropriate conduct in online dating, and, more specifically, to a system and method of reporting inappropriate conduct of a bad actor exploiting a plurality of dating applications.

### BACKGROUND

Online dating offers many benefits. First there is convenience. It can be easier to find and connect with potential partners online, as one can do so from the comfort of their own home at a convenient time. There is also access to a wider pool of potential partners than one might find in their everyday life. With online dating, one also has more control over the process of finding and connecting with potential partners. One can take their time to review profiles and message people who seem like a good match. Online dating also offers the opportunity to get to know someone through messaging and other forms of communication before meeting in person, which can help one feel more comfortable and prepared for the first date.

Online dating is facilitated by various known online dating applications (ODAs) such as Tinder (known for its swiping feature and wide user base); Bumble (women initiate conversations); Hinge (emphasizes on meaningful connections by providing prompts); OkCupid (offers a wide range of questions to match users based on compatibility); Match.com (one of the first dating platforms, offering a variety of features for matching); Plenty of Fish (known for its extensive user base and free features); Grindr (geared towards LGBTQ+ community); Her (designed for LGBTQ+ women and non-binary individuals); and eHarmony (emphasizes long-term relationships using a compatibility matching system), just to name a few.

ODAs can be an effective way to meet new people, but because ODAs avoid the need for in person meeting initially, they can also facilitate inappropriate behavior that would not occur during in-person meeting. “Inappropriate behavior” on ODAs ranges widely, from sexist pick-up lines, to full-blown threats and abuse. But many of the most common transgressions fall somewhere in the middle Examples of inappropriate behavior on ODAs include:
Harassment: This can include sending unwanted or threatening messages, making inappropriate comments or advances, or stalking someone online.
Assault: this includes committing physical/sexual harm or unwanted physical/sexual contact.
Scamming: Some people may try to scam others by asking for money or personal information under false pretenses.
Catfishing: This is when someone creates a fake profile or identity in order to deceive or manipulate others into giving them money, goods, or sex. Often, scammers will catfish others using pictures of actors, athletes, models, or soldiers.
Kittenfishing: Kittenfishing is the “lite” version of catfishing. While catfishers fabricate a totally fake identity, kittenfishers use their own identity, but exaggerate or fake aspects of their identity to look more attractive. Here are some examples of kittenfishing:
   Using profile pictures that are several years old
   Photoshopping profile pictures
   Shaving several years off of their real age
   Drastically lying about their weight or height
   Exaggerating about their job
Gaslighting: This is when someone manipulates or lies to someone in order to make them question their own reality or sanity
Ghosting: This is when someone suddenly cuts off all communication without explanation, ignoring the other person's text, calls, and carrier pigeon memos, ceasing all contact. Some psychologists believe ghosting is a form of emotional cruelty and deepens feelings of abandonment and desertion.
Zombieing: Zombies are ghosters who suddenly, but weakly, come “back from the dead. Long after a “zombie” ghosts you, they'll send you a very short message, like “hey”. They might also like one of your social media posts. Sometimes, they'll give you a lame excuse for why they were gone.
Haunting: similar to zombieing, but haunting is focused on social media. Haunters will suddenly like a few of your posts or view your Instagram story after you've ended a relationship with them, to eerily remind you that they exist and lurk in your digital world. Haunting usually occurs after the person ghosted you, but can also happen after you've ended a relationship more seriously.
Orbiting: Orbiters will stop responding to all of your messages (so, they'll basically ghost you), but they'll consistently observe your digital life. They'll leave plenty of likes on your social media posts and constantly watch your stories, but they won't send you a single message (or leave a single comment). In other words, orbiting is haunting on overdrive, and it can mess with your emotions even more.
Submarining/prowling: Another zombie-like behavior—Submarining is when a ghoster “resurfaces” several months later by sending you a message, but act like nothing has happened and will not acknowledge or apologize for the ghosting. Some people group submarining and zombieing together as identical inappropriate behaviors. Others call the resurfacing behavior “zombieing” when there is a lame apology and “submarining” when there is no apology.
Breadcrumbing: In the online dating world, some daters will also leave “breadcrumbs:” flirty messages to pique your interest, even though they're not even close to interested in a serious relationship with you. Many people who use breadcrumbing are afraid to formally end a relationship, but don't want to date you in-person, so they see those low-commitment flirty messages as the next best route.
Slow Fading: slow fading is a specific form of ghosting—when a match gradually phases out of a relationship by canceling plans and reducing communication, and then cuts you off completely.
Cushioning/Cookie Jarring: Cushioning is a form of cheating, but without physical contact. It's when someone, who is already in an exclusive relationship, messages others to express their interest in a relationship. Some cushioners think their existing relationship is about to end, or don't trust the solidity of their main relationship, so they build up relationships with other prospects as a “plan B.” Cushioners often lie about their relationship status in their profile.
Benching: Benching is when someone isn't interested in a committed relationship with you, but wants a backup plan in case their main relationship doesn't work out. They send you messages to keep you from giving up on them, stringing you along all the while. It's different from cushioning because while cushioners seek to build up a relationship with you as a backup, benchers put little effort into their “plan B” picks—only just enough for you to keep them around. In other words, Benching is when you are clearly someone's Plan B or C while they clearly shop around for a better ‘deal’.

. Roaching: Roaching is when someone pursues a relationship with you, but hides the fact that they're in committed relationships with multiple others. Then, when you call them out, they blame you for expecting exclusivity.
Stashing: This term denotes being someone's guilty secret with no introductions to friends or family.

Negative dating site experiences, such as ghosting, lead people to question their physical traits, communication skills, and compatibility with potential dates. Consequently. ODA users tend to experience more mental health problems than non-users. These mental health issues could be related to regular rejection and frequent self-doubt Thus, there is a general need to track and minimize inappropriate behavior in ODAs.

Most ODAs have reporting and blocking features. For example, most ODAs have tools that allow you to report or block users who are behaving poorly. But Applicant appreciates that these blocks are only useful “after the fact” and are not prophylactic to allow a user to avoid inappropriate behavior. Also, such reporting is limited to just one particular dating site, which is ineffective because many people use multiple dating apps.

More recently, a community of people who use ODAs have formed groups to report inappropriate behavior. For example, on Facebook.com, groups are formed to determine if the same person is dating multiple people in “Are We Dating The Same Guy.” On that site, women exchange information on the men they are dating to confirm that he is indeed being exclusive. While this approach may serve to “out” a guy who is lying about his exclusive status, it is unfortunately retroactive, not prophylactic, and fails to track other inappropriate behavior on ODAs.

Another Facebook group is “vouched dating” in which women must vouch for a man to join the dating site or venue. While this does have the benefit of identifying “good guys,” it does nothing to identify offenders.

Accordingly, Applicant has identified the need for a prophylactic approach for warning users of ODAs of inappropriate conduct of other users across all ODAs. The present invention fulfills this need among others.

### SUMMARY OF INVENTION

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

In one embodiment, the present invention is a method of monitoring inappropriate behavior of a user exploiting at least one online dating application (ODA). In one embodiment, the method comprises: (a) receiving a report from a first user of an ODA accusing a second user of said ODA of inappropriate behavior, said report including one or more identify parameters of said second user, and a selection from a list of inappropriate behaviors, wherein said report is anonymized to prevent public disclosure of said first user's identity; (b) matching said one or more identify parameters of said report to one or more stored identify parameters of other reports in a datastore; (c) determining if said second user has a pattern of inappropriate behavior if said one or more identify parameters of said report match said one or more stored identify parameters; and (d) if said pattern of inappropriate behavior is determined, providing an indication of said second user's inappropriate behavior to users of a plurality of ODAs.

In one embodiment the present invention is a system of monitoring inappropriate behavior of a user exploiting at least one online dating application (ODA). In one embodiment, the system comprises: (a) an API to receive reports of inappropriate behavior from a user of at least one ODA; (b) a report data store to store reports of said inappropriate behavior; (c) an interface service to determine patterns or correlations between said reports of said inappropriate behavior; (d) a profile data store to store one or more determinations of patterns or correlations between said reports of said inappropriate behavior; (e) an API to transmit said one or more determinations in response to queries from a user of an ODA.

### BRIEF DESCRIPTION OF FIGURES

FIG. 1 shows a typical online dating application (ODA) profile screen with the Reputation platform icon added.

FIG. 2A-2B show embodiments of screenshots when the Reputation icon is selected.

FIG. 3A-3C show an example of one query of a user desiring to report inappropriate behavior.

FIG. 4 shows one embodiment of the system of the present invention.

### DETAILED DESCRIPTION

Throughout this disclosure, the following terms are used to describe the people involved in this reporting platform: “user” is a person who uses an ODA; “reporter” is a user reporting inappropriate behavior of another user; “accused user” is a user who has been accused of inappropriate behavior; “offender” is an accused user whose inappropriate behavior has been confirmed.

Applicant recognizes that a system for tracking inappropriate behavior on ODAs and warning other ODA users of this inappropriate behavior should have several attributes.

First, Applicant recognizes that the system should focus on serial offenders. Applicant recognizes that the majority users of ODAs are respectful and polite. Indeed, the offenders of ODAs represent a relatively small fraction of total users. But these offenders tend to be serial offenders across different ODA platforms. Thus, this relatively small fraction of users has a disproportionately large negative impact on ODAs. Additionally, a serial offender will establish a pattern of inappropriate behavior. This pattern then can be used to predict inappropriate behavior in the future, thus making the approach prophylactic. Accordingly, Applicant recognizes that a prophylactic approach for monitoring inappropriate behavior on ODAs should target these serial offenders.

Second, Applicant recognizes that establishing a pattern of a serial offender requires that a user report the inappropriate behavior. Yet most inappropriate behavior goes unreported because the victim does not want to be identified or otherwise get involved personally in the report for fear of retaliation and even legal action. Fear, social blaming, and isolation continue to be key factors that cause victims to remain silent. This is especially the case for a victim believing that the inappropriate behavior was isolated to just them. In other words, if the victim does not appreciate that the offender is likely a serial offender and is likely to perpetrate the inappropriate behavior on others, the incentive for reporting is low.

To encourage reporting of inappropriate behavior on ODAs, a victim of inappropriate behavior on ODAs should understand that offenders are likely serial offenders, so whatever happened to the victim is probably not isolated to the victim. If the user understands that reporting the inappropriate behavior may help others in the future, the user is more likely to do so. Additionally, the reports of inappropriate behavior on an ODA should be anonymous to avoid fear or retaliation, social blaming, or just “getting involved” In one embodiment, the present invention provides for an anonymous reporting platform. Such anonymous reporting platforms are known in different applications. For example, JDoe is already available as an anonymous platform for reporting sexual misconduct (https://jdoe.io/). Additionally, reporting inappropriate behavior needs to be convenient, and preferably involves just a few inputs from the ODA Once the system begins to collect reports of inappropriate behavior, it can begin to analyze the data to identify the serial offenders.

Third, Applicant recognizes that reporting should not be isolated to a particular ODA, but rather should aggregate data from all ODAs The primary reason for this is that most offenders operate on a plurality of ODAs, and, thus, to capture the real impact of an offender, the offender's inappropriate behavior over multiple ODAs should be aggregated.

Fourth, Applicant also recognizes that for reliable reporting, the inappropriate behavior needs to be defined accurately and precisely. In other words, the inappropriate behavior should be described in objective terms so that it is useful in comparing similar accounts from different victims To this end, one approach is to provide the victim with a finite and standardized set of inappropriate behaviors to report. Further, it may be beneficial to provide examples of each inappropriate behavior to ensure continuity of responses For example, in one embodiment, the inappropriate behavior is described as follows:
After one or more dates, accused user failed to respond to multiple communications from user over at least a two week period;
accused user failed to show up for a scheduled date with user with excuse;
accused user failed to show up for a scheduled date with user without excuse;
accused user has false information in their profile;
accused user used a false/modified picture in their profile;
accused user went outside agreed/customary channels of communications when contacting user;
accused user posted inappropriate/disparaging content regarding user on social media
accused user posted inappropriate image of user on social media
accused user transmitted inappropriate images or text to user
accused user transmitted unwanted sexually explicit images or text to user
accused user continued to contact user after user communicated to accused user to stop all contact;
accused user stalked user on social media;
accused user approached user in person unexpectantly and/or without invitation;
accused user stalked user physically;
accused user physically assaulted user;
accused user sexually assaulted user; and
User filed a police report on accused user.

In one embodiment, the reporting platform walks the user through a hierarchy of categories of inappropriate behavior to determine a more specific inappropriate behavior. For example, in one embodiment the following hierarchy is used:

### Rudeness

After one or more dates, accused user failed to respond to multiple communications from user over at least a two week period;
accused user failed to show up for a scheduled date with user
with excuse;
without excuse;

### Fraudulent

accused user scammed user
accused user attempted to scam user accused user has false information in their profile;
accused user used a false/modified picture in their profile;
accused user profile name is incorrect

### Harassment

accused user went outside agreed/customary channels of communications when contacting user;
accused user continued to contact user after user communicated to accused user to stop all contact;
accused user posted inappropriate/disparaging content regarding user on social media
accused user posted inappropriate image of user on social media accused user transmitted inappropriate images or text to user
accused user transmitted unwanted sexually explicit images or text to user
accused user stalked user on social media
accused user approached user in person unexpectantly and/or without invitation;

### Threatening/Violent

accused user stalked user physically;
accused user physically assaulted user;
accused user sexually assaulted user;
   User filed a police report on accused user.

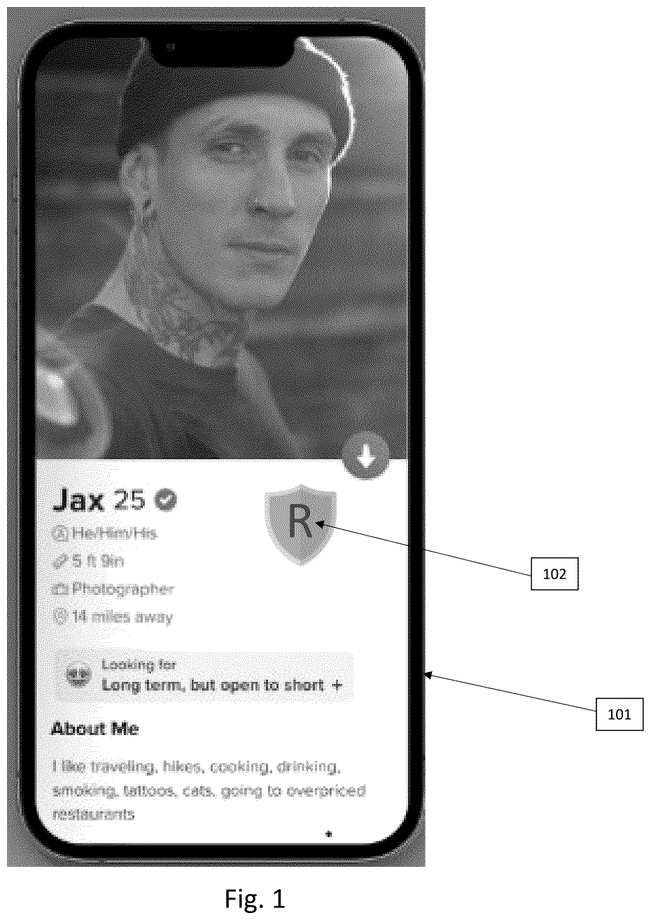

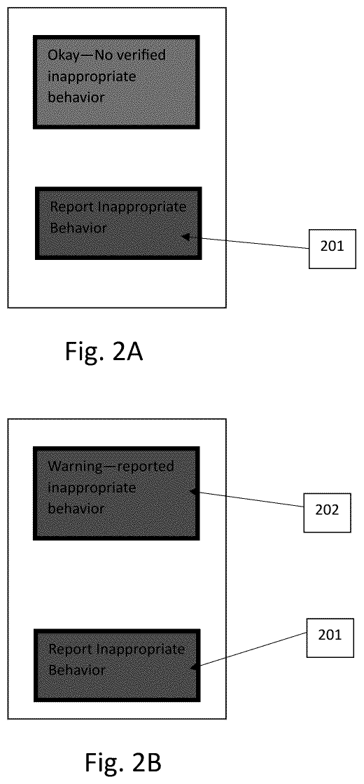

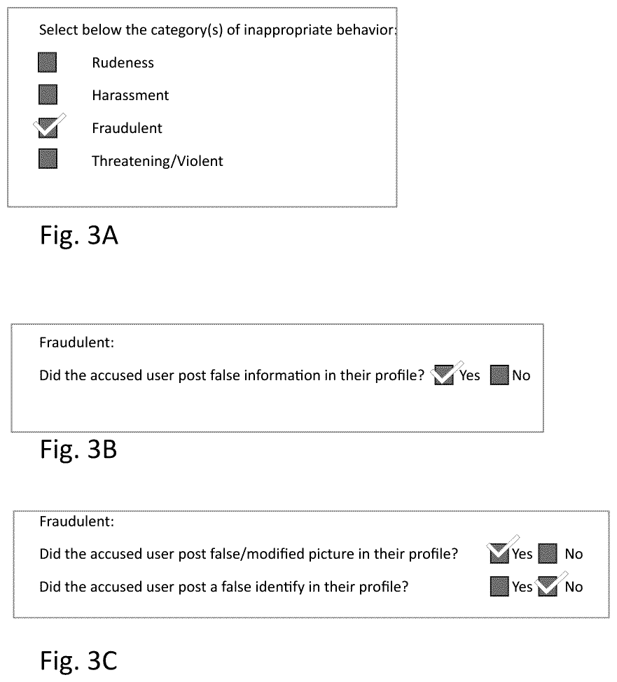

Referring to FIGS. 1-3, one embodiment of the use of this hierarchy is shown. Specifically, a user may report another user for inappropriate behavior by going to their profile 101 in the ODA. Next, the user would select the Reputation icon 102. Selecting this icon would take the user to one of two pages, either a first page shown in FIG. 2A, which indicates that no inappropriate behavior has been reported, or a second page as shown in FIG. 2B, which indicates that inappropriate behavior has been reported. Regardless, each page provides a button 201 to report inappropriate behavior. To report inappropriate behavior, the user would then select the report button, which, in one embodiment, would take the user to the page shown in FIG. 3A. In this particular embodiment, four different categories of inappropriate behavior are listed—i.e. rudeness, harassment, fraudulent, and threatening/violent. The user would then select one or more of these categories. Depending upon the selection, additional screens will be displayed to specify the inappropriate behavior.

For example, as shown in FIG. 3A, if the user selects fraudulent, the screen of FIG. 3B would be displayed, querying whether the accused user posted false information in their profile. If the answer to this is yes, then the user would be prompted by the screen of FIG. 3C, which further queries whether the false information was a false or modified picture in their profile or a false identity in their profile. In this particular example, the user has indicated that the accused user has posted a false or modified picture in their profile but has not posted a false identity.

If the user selected more than one category of inappropriate behavior, the system would hierarchically query the user for a specific inappropriate behavior for each category.

This information then would be added to the accused user's reputation/profile database, and when a sufficient pattern or level of severity has been reached for the accused user, the accused user will be considered an offender and their status as a verified offender will be indicated in the reputation database such that, when a user queries the reputation of this offender, the screen shown in FIG. 2B will be displayed, indicating the user as an offender.

Fifth, Applicant recognizes that the accused user should be protected from fraudulent/malicious complaints. Dating is not always a pleasant experience. Frequently one party is left disappointed/angry over the relationship. This does not mean that the other party has done anything wrong or in any way perpetrated inappropriate behavior Thus, Applicant recognizes that users of ODAs should be protected from unfounded allegations of inappropriate behavior.

Applicant discloses herein various approaches for verifying the veracity of a complaint. For example, in one embodiment, the system/method of the present invention requires a predetermined number of complaints to be filed by different people for the same accused user before that accused user is deemed to be an offender. The predetermined number may be fixed or may vary based upon the severity of the complaint. For example, in one embodiment, if the inappropriate behavior is of a nonthreatening/nonviolent nature, then a plurality, for example, two or more reports filed by two more different victims would be needed to indicate a warning for that particular offender It should be understood that the threshold for establishing a pattern of inappropriate behavior (i.e. how many reports of inappropriate behavior must be filed before the accused user is determined to be an offender) may be modified as data is acquired indicating a pattern of inappropriate behavior.

In one embodiment, as the number of reports from different victims increases with respect to a particular offender, the magnitude of warning increases as discussed below. If, however, the report is of a violent nature (e.g. assault), just one report from a victim might be enough to issue a warning on that offender For example, in one embodiment, if a user files a police report on an accused user, then an immediate high magnitude warning may be issued on the accused user.

Another approach for validating a victim report is to ensure that the victim is a real person while maintaining the anonymity of the victim. This can be done in different ways. For example, in one embodiment, the victim may have to register with the reporting platform to provide information that verifies the identity of the victim, but provides a random identification code such that the victim's identity remains anonymous to the public. If such an approach is used, privacy assurances, including, for example, encryption/passwords/dual authentication/etc. should be used to safeguard the user's identify.

Once the identity of a person reporting inappropriate behavior is protected/secured, that person's reports can be monitored to determine malice. For example, if the same user makes multiple reports of inappropriate behavior for the same person, or similar reports of inappropriate behavior for different people on a timeline that seems inconsistent with observed trends of inappropriate behavior, then the Reputation system/method may discount that person's reports, or disregard them altogether as being fraudulent. Likewise, if the same user files multiple reports of inappropriate behavior for different people, yet no other reports of inappropriate behavior had been filed for the different people, that user may be deemed unreliable. Still other algorithms to determine unreliable reports will be obvious to those of skill the art in light of this disclosure.

Another approach for ensuring that a user is not wrongly accused, is to allow the accused user an opportunity to challenge or refute the accusation, although such opportunity needs to be weighed against compromising the anonymity of the reporter.

It should be understood that other criteria for ascertaining the credibility of a reporting user will be obvious to those of skill in light of this disclosure.

Sixth, Applicant also recognizes that not all inappropriate behavior should be treated the same. Some inappropriate behavior is worse than others, obviously. For example, catfishing is a more serious offense than ghosting, assault is far more serious than failing to show up for a date, etc. Accordingly, in one embodiment, the reported inappropriate behavior for a given offender is made available for viewing for an inquiring user. Although this approach allows the user to assess the level of severity of the inappropriate behavior for themselves, posting the actual reported inappropriate behavior may compromise the victim's anonymity, especially if the postings include additional information such as date of offense or date of reporting. Accordingly, in one embodiment, it may be preferable to reduce the resolution of the reported inappropriate behavior, and, instead, quantify the inappropriate behavior on a scale, for example, from 1 to 10. One such quantification inappropriate behavior set forth below. It should be understood that this is an example and that others may reevaluate the weight/value placed on the inappropriate behavior.

Accordingly, in one embodiment, the magnitude of the warning is indicative of the severity of the inappropriate behavior. To this end, in one embodiment, the various inappropriate behaviors are given values. For example:

| Inappropriate behavior | Severity Value |
|---|---|
| After one or more dates, accused user failed to | 1 |
| respond to multiple communications from user | |
| over at least a two week period; | |
| accused user canceled a scheduled date with user | 1 |
| more than once. | |
| accused user failed to show up for a scheduled date | 1 |
| with user but provided explanation | |
| accused user failed to show up for a scheduled date | 2 |
| with user with no explanation | |
| accused user went outside agreed/customary | 2 |
| channels of communications when contacting user | |
| accused user has false information in their profile | 3 |
| accused user used a false/modified picture in their | 4 |
| profile | |
| accused user posted inappropriate/disparaging | 3 |
| content regarding user on social media | |
| accused user posted inappropriate image of user on | 6 |
| social media | |
| accused user continued to contact user after user | 3 |
| communicated to accused user to stop all contact; | |
| accused user stalked user on social media; | 3 |
| accused user approached user in person | 4 |
| unexpectantly and/or without invitation; | |
| accused user transmitted inappropriate images or | 4 |
| text to user | |
| accused user transmitted unwanted sexually | 5 |
| explicit images or text to user | |
| accused user stalked user | 6 |
| accused user stalked user -police report filed | 7 |
| accused user physically assaulted user | 8 |
| accused user physically assaulted user-police | 9 |
| report filed | |
| accused user sexually assaulted user | 9 |
| accused user sexually assaulted user-police report | 10 |
| filed | |

In one embodiment, rather than listing the particular inappropriate behavior, just a numerical value of the severity of the inappropriate behavior is posted. In another embodiment, rather than listing a value for each reported inappropriate behavior, an aggregate value is provided. In this embodiment, it may be preferable, in addition to having an aggregate value of inappropriate behavior, to indicate quantity of inappropriate behavior reports made, and, in one embodiment, to indicate if any of the reported inappropriate behavior was violent in nature. In one embodiment, any report of an assault in which a police report was filed which carry its own indication/warning

In one embodiment, the warning is associated with the degree of confidence in the reported inappropriate behavior. For example, as the number of reporters reporting the same inappropriate behavior for the same accused user increases, the confidence in that reported inappropriate behavior increases. Accordingly, in one embodiment, the warning may indicate a confidence level, based on for example, a scale from 1 to 10. Such an approach may be preferred to balance the need to inform the public as soon as possible of possible inappropriate conduct, with the possibility that the report of inappropriate conduct is not reliable. Those of skill in data analytics will understand, in light of this disclosure, the reliability of the reported inappropriate behavior.

As described herein, the warning level may increase as the number of reports from different victims are received, and/or as the severity of the inappropriate behavior is reported. In one embodiment, the magnitude of the warning increases as the aggregate increases.

Those of skill the art will appreciate that the warnings may take on various embodiments. For example, a color system may be used for the level of warning with escalating magnitude illustrated in a progression of colors from yellow, orange, red, with red being the most serious. Obviously, other color codes could be used. In one embodiment, if violent inappropriate behaviors reported, the warnings may have another attribute side from color—e.g. flashing. For example, referring to FIG. 2B, in one embodiment, the warning block 202 may be color-coded or flashing to indicate the level of warning. Alternatively, rather than specifying the warning with a color, a precise description of the inappropriate behavior may be provided as the warning as described above, or simply the above mentioned aggregate of quantified inappropriate behavior can be displayed. For example, referring again to FIG. 2B, in one embodiment, the warning block 202 may be a button that the user may select to reveal additional information regarding specifics of the inappropriate behavior reported.

Seventh, Applicant recognizes that offenders often use aliases and change their profile among different ODAs. Accordingly, Applicant discloses basing the offender's identity on something in addition to their supposed name.

For example, in one embodiment, the offender's identity defined by a facial recognition module. Facial recognition is a mature technology (although constantly evolving) and thus, they will not be described in detail herein. Suffice it to say that facial recognition is a technology that uses computer algorithms to match a person's facial features to a database of stored facial images. It typically works by first obtaining the image of the accused user The user using the system may acquire this image on their cell phone or the like, or instead, use the image that is posted on the accused user online profile, which, in one embodiment may be done using the automatic data upload feature described below. Even if the image is not the correct image of the accused user, or the image has been modified, if the accused user consistently uses the fake image for altered image can nevertheless be used to identify the accused user. The system then converts the image into a numerical representation, or “template,” by extracting and measuring various facial features, such as the distance between the eyes and the shape of the cheekbones. This template is then used in the offender's profile, and compared to other templates to determine matches among different users' reports of inappropriate behavior. If a match is found, the system will determine that the reports of inappropriate behavior are connected to the same accused user, and therefore will consolidate the reports of inappropriate behavior for the single accused user. Thus, in this embodiment, the reporter would provide the offender's picture online which would be processed through a facial recognition program to facilitate its correlation to other pictures provided by other victims.

Alternatively, if the facial recognition template of the accused user corresponds to different usernames across different ODAs, then that is an indication that the accused user is using aliases on different ODAs, which, in one embodiment, would prompt a warning. Likewise, if the facial recognition template corresponds to a different user other than the accused user, this could be evidence that the accused user has misappropriated their profile image. In one embodiment, each profile image across each ODA is processed and correlated to the profile name or other identification parameter to build a database to ensure identity integrity.

Aside from facial recognition, other identity parameters and be used to match accused users from different reports. Examples of these other identity parameters include the following:
cell phone number;
email address;
license plate number;
physical attributes such as height and weight and eye color;
driver license information;
street address;
employment information; and
social media accounts.

It should be understood that these are just a few of the different ways to identify a person aside from their name. In one embodiment, a positive identification match is established when a portion of the above identified identity parameters are matched, for example three or more. It should also be understood that many of these data points may be uploaded automatically from the accused user online profile.

Eighth, Applicant recognizes that one approach to increasing compliance and acceptance of this reporting system and to avoid conflict/retaliation from accused users/offenders is to have users of ODAs voluntarily submit or “opt in” to the reputation/reporting platform. In other words, when signing up on a particular ODA, the user is asked whether they submit to the reputation/reporting platform as disclosed herein. This may include, for example, an agreement to release their profile data to the Reputation platform, and to relinquish any legal recourse against the Reputation platform or reporters. Such a release of legal recourse may be moderated by a condition that the reporting user is acting good faith and without malice. Such moderation may be embodied in an appeal process by the accused user as discussed below.

In one embodiment, their acceptance to being held accountable by the reputation/reporting platform will be noted on their profile. Likewise, if they refuse to be held accountable by the reputation/reporting platform will also be indicated on their profile. Thus, users reviewing a person's profile will know whether this person feels comfortable enough to submit to the reputation/reporting platform, or whether they prefer to be held unaccountable. Thus, the user reviewing a person's profile can make an informed decision will make an informed decision based on the person's willingness to be held accountable.

Another benefit of having users opt in to the reporting or Reputation platform is the user will be put on notice that their behavior can now be reported, and thus the user might be more circumspect in their behavior.

Still another benefit of having the user opt in to the reporting platform is it provides the ODA with the defense that the user consented to it if the user attempts to pursue a defamation or similar legal attack because of a negative report.

Ninth, Applicant recognizes that in some cases it might be worth providing the accused user with a warning that their conduct has been reported, or an indication that if they receive additional reports (e.g. one more report, two more reports . . . ) of inappropriate behavior that that you will be deemed an offender and an alert posted on his profile. Such a warning may have a beneficial effect of curbing inappropriate behavior or at least making the person more cognizant that they are being held accountable. Obviously, being able to report serial inappropriate behavior is important as the focus of this application, but being able to moderate or stop the inappropriate behavior would even be better.

The preferred reporting system of the present invention has at least two, or at least three, or at least four, or at least five, or at least six, or at least seven, or at least eight, or all of the above described attributes—in any combination.

The reporting system and method of the present invention can be implemented in a variety of ways. For example, in one embodiment, is a browser-based standalone application, or a downloadable mobile application. In one embodiment, to facilitate the transfer of data from the ODA to the reporting platform, the reporting by phone could be implemented as a browser extension, or more preferably as a API in the ODA.

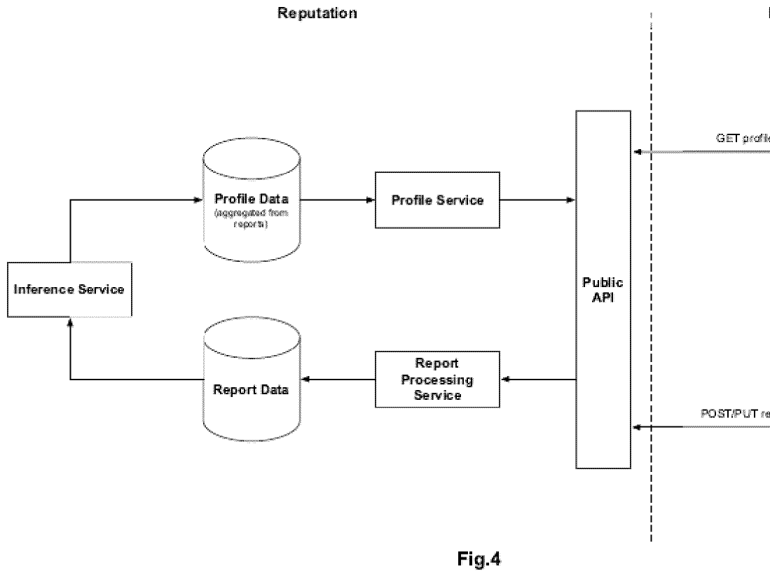

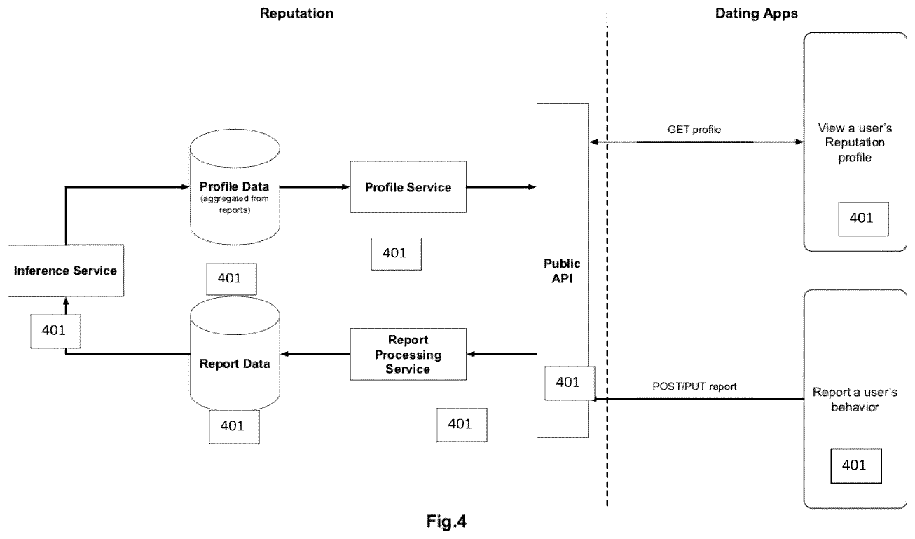

Referring to FIG. 4, one embodiment of the reporting/reputation system of the present invention is shown. The system will be described as a sequence of reporting inappropriate behavior to receiving a warning of inappropriate behavior. First, the report of inappropriate behavior is reported on a first user's ODA via phone 401. Although a single phone is depicted in FIG. 4, it should be understood that multiple phones multiple incidences of inappropriate behavior on multiple ODAs. The report is received in a public API 402 operated by the reporting/Reputation platform. Next, the data is received by a report processing service 403. The report processing service functions to receive raw data from a reporting user and to enrich and normalize that data for storage on a report data store 404.

In one embodiment, the significant data processing occurs at the interface service 405. Here, a processor reads report data and determines patterns and/or correlations indicating inappropriate conduct. The interface service 405 then outputs its results to the profile data store 406.

The profile service 407 response to inquiries from users for reputation information and transmits data in a format consistent with the ODA used by the user. This information is transmitted across the public API 402 to the cell phone 408 of a user of one or more OD As, thereby displaying for the user of the ODA the reputation of an another user of the ODA.

In one embodiment, the reporting platform is more readily used if integrated with the ODA as an API such that, in one embodiment, all the user needs to do is to tap on a “Reputation” button (for example) to determine if a user of interest on the ODA has a pattern of inappropriate behavior, or tap on a “Report” button (for example) to report inappropriate behavior of a user. In one embodiment, simply tapping the report button would upload the accused user's profile as well as the profile of the reporter into the reporting platform. Next, the reporter would be given a list of inappropriate behaviors to select from. In one embodiment, the reporter would simply select one or more of the inappropriate behaviors to be reported, certify the truthfulness of the accusation, and hit enter. In one embodiment, if a police report or other documentation of the inappropriate behavior exists, the system may request identification information for such a verifiable police report or other documentation. The reporting platform will do the rest.

As mentioned above, in one embodiment, once the report has been entered, the system checks to determine if the accused user can be matched with other reports of inappropriate behavior in the system's datastore. As described above, the matching may involve correlating various identification parameters. If a match is determined, and the accused user is not already determined to be an offender, a determination is made whether the accused user's inappropriate behavior equates to a pattern of inappropriate behavior. As mentioned above this can be done in various ways, including, for example, determining if the number of reports from different reporters exceed a predetermined threshold (e.g., two, three, four, five, six, etc.); determining if the reported inappropriate behavior is consistently the same over a threshold number of reports (e.g., two, three, four, five, six, etc.); determining if a police report has been filed; or determining if the aggregated quantification of the severity of the reported inappropriate behavior exceeds a threshold. Still other ways of determining a pattern of inappropriate behavior will be obvious to those of skill in the art in light of this disclosure.

In one embodiment, a determination is made whether the report is being filed in good faith. This can be done in various ways. For example, in one environment, a determination is made whether the reporter has a pattern of reporting inappropriate behavior that is outside realistic norms, or whether the report is correlated with other reports targeting the same accused user that suggests a bad faith effort among different reporters the target a particular accused user. Those of skill the art will understand the various statistical methods to determine when a report is outside anticipated norms.

These and other advantages maybe realized in accordance with the specific embodiments described as well as other variations. It is to be understood that the above description is intended to be illustrative, and not restrictive. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled.

What is claimed is:

1. A method of monitoring inappropriate behavior of a user exploiting at least one online dating application (ODA), said method comprising:
receiving a report from a first user of an ODA accusing a second user of said ODA of inappropriate behavior, said report including one or more identify parameters of said second user, and a selection from a list of inappropriate behaviors, wherein said report is anonymized to prevent public disclosure of said first user's identity;
matching said one or more identify parameters of said report to one or more stored identify parameters of other reports in a datastore;
determining if said second user has a pattern of inappropriate behavior if said one or more identify parameters of said report match said one or more stored identify parameters; and
if said pattern of inappropriate behavior is determined, providing an indication of said second user's inappropriate behavior to users of a plurality of ODAs.

2. The method of claim 1, wherein said one or more identify parameters comprises at least one of: the name of said second user, known aliases of said second user, address of said second user, cell phone number of said second user, age of said second user, dating app used by said second user, height/weight/eye color of said second user, employment of second user, license plate number of said second user, social media accounts of said second user, email address of said second user, or a face recognition template of an image of said second user.

3. The method of claim 1, wherein matching said one or more identify parameters comprises matching at least two of said one or more identify parameters with two or more of said stored identify parameters.

4. The method of claim 3, wherein matching said one or more identify parameters comprises matching said face recognition template of said second user and one of the other identity parameters of said second user to said stored identify parameters.

5. The method of claim 1, wherein determining said pattern comprises determining if the number of reports having matching identify parameters exceeds a predetermined threshold (e.g., 2, 3, 4, 5, 6, 7, 8, 9, 10 . . . ).

6. The method of claim 1, wherein determining said pattern comprises determining if the reported inappropriate behavior is consistent over a threshold number of reports (e g., 2, 3, 4, 5, 6, 7, 8, 9, 10 . . . ).

7. The method of claim 1, wherein determining said pattern comprises determining if the aggregated quantification of the severity of the reported inappropriate behavior exceeds a threshold (e.g., 5, 10, 15, 20, . . . ).

8. The method of claim 1, said indication comprises at least one warning if a predetermined number of users have reported inappropriate behavior for said second user.

9. The method of claim 1, further comprising providing said indication if said first user files a police report on said second user.

10. The method of claim 1, wherein said indication comprises warnings of different magnitude, wherein said warnings increase in magnitude under at least of the following conditions: (1) the number of users reporting inappropriate behavior for said accused user increase; (2) the reported inappropriate behavior increases in danger; or (3) the same inappropriate behavior of said accused user is reported by different users.

11. The method of claim 11, wherein said dangerous inappropriate behavior is one in which the safety of the user was at risk.

12. The method of claim 11, wherein said warning is linked to said ODA.

13. The method of claim 1, wherein an administrator of said ODA is notified of an accused user when said warning reach a predetermined magnitude.

14. The method of claim 13, wherein administrator of all ODAs that offer the API of the reporting platform are notified of an accused user when said warning reach a predetermined magnitude.

15. The method of claim 1, wherein when said first user reports inappropriate behavior for a predetermined number of different accused users, or said first user transmits a predetermined number of reports of inappropriate behavior for said second user, the said first user is flagged as unreliable and said reports attributed to first user or discounted for dismissed.

16. The method of claim 15, wherein said bad faith is detected by at least one of said first user filing multiple reports on said second user, multiple users filing reports on said second user in a clustered period inconsistent with said second user affiliation with said ODA, reports filed from statistically unlikely locations, reports filed from statistically unlikely time periods, reports filed from statistically unlikely geographical locations, reports filed from statistically unlikely users, reports filed from users that are linked to said first user.

17. The method of claim 16, wherein said users are linked to said first user through social media contacts, including, for example, Facebook friends, and LinkedIn contacts.

18. A system comprising:
an API to receive reports of inappropriate behavior from a user of at least one ODA;
a report data store to store reports of said inappropriate behavior;
an interface service to determine patterns or correlations between said reports of said inappropriate behavior;
a profile data store to store one or more determinations of patterns or correlations between said reports of said inappropriate behavior;
an API to transmit said one or more determinations in response to queries from a user of an ODA.

19. The system of claim 18, wherein said at least one ODA comprises multiple ODA's.

20. The system of claim 18 wherein said API to receive and said API to transmit are the same API.
